(19) United States
(12) Patent Application Publication
(10) Pub. No.: US 2019/0392697 A1
(43) Pub. Date: Dec. 26, 2019

(54) AUTONOMOUS VEHICLE ROAD WATER DETECTION

(71) Applicant: Ford Global Technologies, LLC, Dearbon, MI (US)

(72) Inventors: Oswaldo PEREZ BARRERA, Texcoco (MX); Alvaro JIMENEZ HERNANDEZ, Miguel Hidalgo (MX)

(21) Appl. No.: 16/484,555

(22) PCT Filed: Feb. 9, 2017
(86) PCT No.: PCT/US2017/017124

§ 371 Date: Aug. 8, 2019

(51) Int. Cl. G08B 21/20; G05D 1/00; H04L 29/08

(52) U.S. Cl. CPC G08B 21/20; G05D 1/0088; G01F 23/24; G05D 2201/0213; H04L 67/125

(57) ABSTRACT

A vehicle system includes a water sensor that outputs an alert signal when submerged in water. The system further includes a processor programmed to receive the alert signal, generate an alert message indicating that water has been detected on a road, a present location of a host vehicle, and a water sensor height relative to the road, and command a communication interface to transmit the alert message to a remote server.

### BACKGROUND

The Society of Automotive Engineers (SAE) has defined multiple levels of autonomous vehicle operation. At levels 0-2, a human driver monitors or controls the majority of the driving tasks, often with no help from the vehicle. For example, at level 0 (“no automation”), a human driver is responsible for all vehicle operations. At level 1 (“driver assistance”), the vehicle sometimes assists with steering, acceleration, or braking, but the driver is still responsible for the vast majority of the vehicle control. At level 2 (“partial automation”), the vehicle can control steering, acceleration, and braking under certain circumstances without human interaction. At levels 3-5, the vehicle assumes more driving-related tasks. At level 3 (“conditional automation”), the vehicle can handle steering, acceleration, and braking under certain circumstances, as well as monitoring of the driving environment. Level 3 requires the driver to intervene occasionally, however. At level 4 (“high automation”), the vehicle can handle the same tasks as at level 3 but without relying on the driver to intervene in certain driving modes. At level 5 (“full automation”), the vehicle can handle almost all tasks without any driver intervention.

### BRIEF DESCRIPTION OF THE DRAWINGS

FIGS. 1A and 1B illustrate an example vehicle with a road water detection system in communication with a remote server.

FIG. 2 is a block diagram showing example components of the vehicle, including components of the road water detection system.

FIG. 3 is an example circuit diagram of a water sensor used in the road water detection system.

FIG. 4 is a flowchart of an example process that may be executed by the road water detection system when road water is detected.

FIG. 5 is a flowchart of an example process that may be executed by the road water detection system to determine if the host vehicle can travel through the road water.

FIGS. 6A-6C illustrate example scenarios where the road water detection system detects water on a road.

### DETAILED DESCRIPTION

Without a human driver, an autonomous vehicle may have difficulty detecting water on a road. Even if the autonomous vehicle can detect water on the road, it may not be able to determine the water depth. As a result, the autonomous vehicle may attempt to travel through water that is too deep, causing the autonomous vehicle to become stranded amidst flood waters.

This can be an issue for human drivers as well. When faced with water on a road, human drivers rely on intuition and familiarity with the area to determine if they can drive their car on a flooded road. For instance, a human driver may see if other vehicles of similar size can make it through the water on the road. Another trick is to estimate the depth of the water from partially submerged landmarks. Examples of landmarks include barricades, road dividers, guard rails, grass, etc. Even then, the driver may not be able to know if his or her vehicle can traverse the flooded road without getting stranded.

One solution involves a road water detection system, in a host vehicle, that includes a water sensor that outputs an alert signal when submerged in water. The system further includes a processor programmed to receive the alert signal, generate an alert message indicating that water has been detected on a road, a present location of a host vehicle, and a water sensor height relative to the road, and command a communication interface to transmit the alert message to a remote server. The remote server can aggregate the information received from multiple vehicles and estimate the depth of the water on the road, and transmit that information to other vehicles near the flooded area. With that information, human drivers and autonomous vehicles can make informed decisions about whether the vehicle can drive through the flood.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

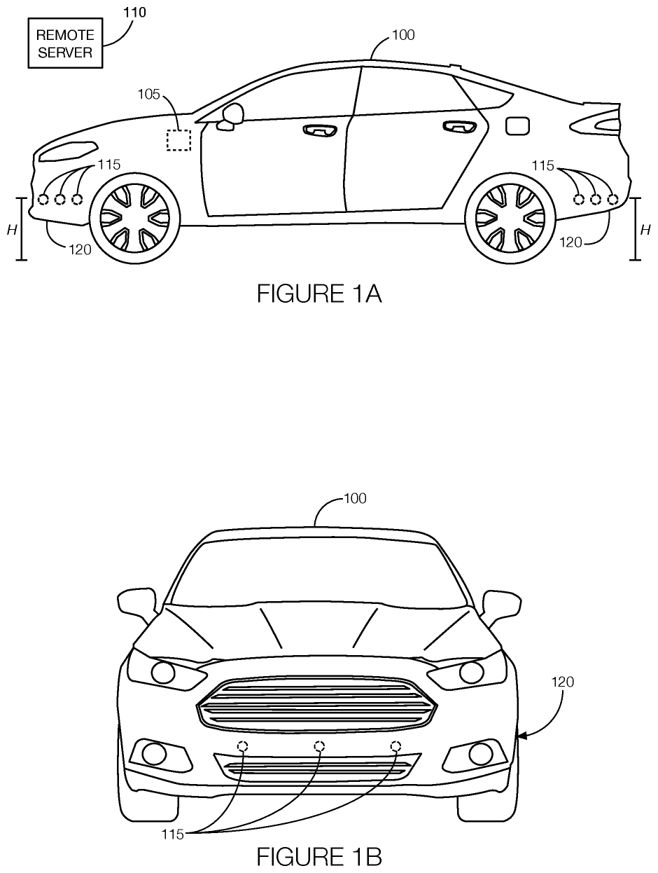

As illustrated in FIGS. 1A and 1B, an autonomous host vehicle 100 has a road water detection system 105 in communication with a remote server 110. The road water detection system 105 includes water sensors 115 located on the host vehicle 100, such as behind the front and rear fascia 120 of the host vehicle 100. The fascia 120 is a cover, with a class A surface, over the front and rear bumpers.

FIG. 1A is a side view of the host vehicle 100 with water sensors 115 located at the front and rear of the host vehicle 100. FIG. 1B is a front view of the host vehicle 100 showing multiple water sensors 115 located at the front of the host vehicle 100. The rear of the host vehicle 100 may also have multiple water sensors 115. As shown in FIGS. 1A and 1B, the water sensors 115 may be located at a generally uniform height relative to the ground. The height may be lower than the depth of water the host vehicle 100 can traverse. For example, if the host vehicle 100 can traverse water at a depth of 18 inches, the water sensors 115 may be located at 12-16 inches from the ground. The water sensors 115 may be at different heights for different vehicles and types of vehicles. For instance, the water sensors 115 on a car may be closer to the ground than the water sensors 115 on a truck or sport utility vehicle. The water sensors 115 may detect water when submerged and output an alert signal indicating that the water sensor 115 has been submerged in water. By outputting the alert signal when the water sensor 115 is submerged, rain or puddles are less likely to result in a false positive (i.e., where the water sensor 115 outputs the alert signal when the water sensor 115 is wet but not submerged).

As discussed in greater detail below, in response to the water sensor 115 outputting the alert signal, the road water detection system 105 generates an alert message indicating that water has been detected on a road. The alert message further includes the present location of the host vehicle 100, the height H of the water sensor 115, and possibly other information. The alert message is transmitted to the remote server 110.

The remote server 110 is implemented via circuits, chips, or other electronic components that receive alert messages from multiple vehicles and store the data included in the alert message in a database. The database may relate the data contained in the alert messages. For instance, the height H of the water sensor 115 and the location of the vehicle at the time the alert signal was generated may be related. From the aggregated information, the remote server 110 may estimate the depth of the water. For example, if water sensors 115 located 12 inches, 16 inches, and 20 inches off the ground detected the water at a particular location of a road, the remote server 110 may estimate the depth of the water to be at least 20 inches. If water sensors 115 located 12 inches off the ground detected the water at the particular location of the road, but the water sensors 115 located 16 inches and 20 inches off the ground did not, the remote server 110 may estimate that the depth of the water is less than 16 inches. The remote server 110 may be programmed to transmit road water data, such as the estimated depth of the water, the location of the water, etc., in response to a query from a water detection system in a host vehicle 100.

The road water detection system 105 may periodically query the remote server 110 for nearby locations where water has been detected on the road. The remote server 110 may transmit the road water data to the road water detection system 105, which may output signals to control the host vehicle 100 accordingly. For instance, the road water detection system 105 may determine whether the host vehicle 100 can travel through the water on the road given the depth of the water and the height of the host vehicle 100. If not, the road water detection system 105 may reroute the path of the host vehicle 100 or output a warning to the driver of the host vehicle 100 to seek a different route.

If water is detected on the road but the remote server 110 does not have any road water data at that location, which could mean that the road water detection system 105 cannot know how deep the water is on the road, rather than proceed through the water, the host vehicle 100 could present a warning to the driver to proceed with extreme caution and recommend that the driver take a different route. If the host vehicle 100 is operating autonomously, the road water detection system 105 may prompt an occupant to visually inspect the road and provide a user input indicating whether the host vehicle 100 should attempt to travel through the water on the road. If the host vehicle 100 is unoccupied while operating autonomously, the host vehicle 100 may automatically seek a different route or transmit a message to an owner of the host vehicle 100 requesting instruction. The message may include an image of the road ahead of the host vehicle 100.

Although illustrated as a sedan, the host vehicle 100 may be any passenger or commercial automobile such as a car, a truck, a sport utility vehicle, a crossover vehicle, a van, a minivan, a taxi, a bus, etc. Further, the host vehicle 100 is an autonomous vehicle that can operate in an autonomous (e.g., driverless) mode, a partially autonomous mode, and/or a non-autonomous mode.

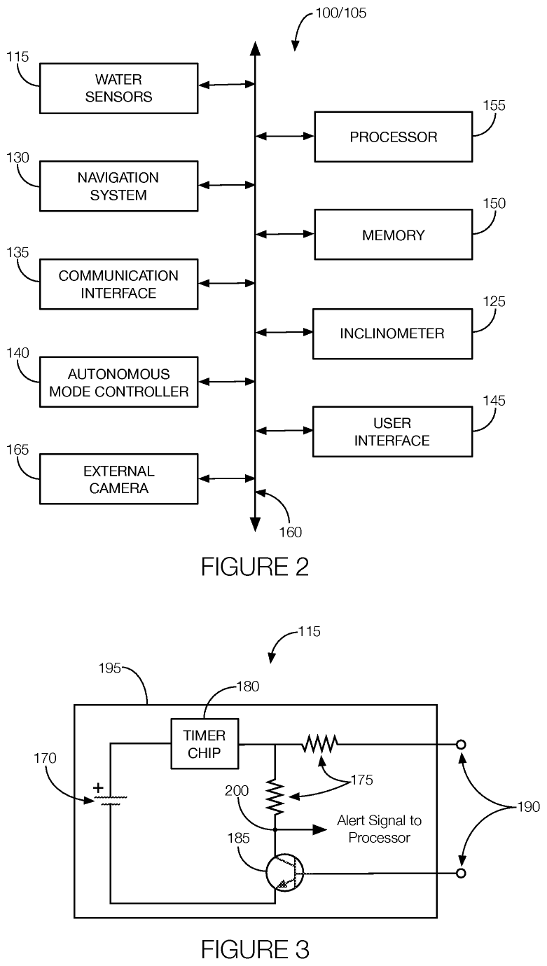

FIG. 2 is a block diagram showing example components of the vehicle, including components of the road water detection system 105. The components shown in FIG. 2 are the water sensors 115, an inclinometer 125, a navigation system 130, a communication interface 135, an autonomous mode controller 140, a user interface 145, a memory 150, and a processor 155. At least some of the components may be in communication with one another over a communication network 160. The communication network 160 includes hardware, such as a communication bus, for facilitating communication among vehicle components. The communication network 160 may facilitate wired or wireless communication among the components of the road water detection system 105, other components of the host vehicle 100, or both, in accordance with a number of communication protocols such as controller area network (CAN), Ethernet, WiFi, Local Interconnect Network (LIN), and/or other wired or wireless mechanisms.

The water sensors 115 are each implemented via circuits, chips, or other electronic components that can detect water. An example circuit diagram of the water sensors 115 is shown with respect to FIG. 3. When the water sensor 115 is submerged, the water sensor 115 outputs an alert signal. The alert signal represents that at least part of the host vehicle 100 has been submerged in water. Thus, the alert signal indicates a flood at the present location of the host vehicle 100.

The inclinometer 125 is implemented via circuits, chips, or other electronic components that detect an incline of the host vehicle 100. The inclinometer 125 may output a signal representing the detected incline. The host vehicle 100 may be at an incline if, e.g., the road is sloped. The signal output by the inclinometer 125 may indicate the angle of the host vehicle 100 relative to a horizontal plane. Such information may be useful since the incline of the host vehicle 100 may affect how the road water detection system 105 reports the depth of the water on the road.

The navigation system 130 is implemented via circuits, chips, or other electronic components that can determine a present location of the host vehicle 100. The navigation system 130 may be implemented via satellite-based system such as the Global Positioning System (GPS). The navigation system 130 may triangulate the location of the host vehicle 100 based on signals received from various satellites in the Earth's orbit. The navigation system 130 is programmed to output signals representing the present location of the host vehicle 100 to, e.g., the processor 155 via the communication network 160. In some instances, the navigation system 130 is programmed to determine a route from the present location to a future location, including developing alternative routes if a road is flooded. The navigation system 130 may access a virtual map stored in the memory 150 (discussed below) and develop the route according to the virtual map data.

The communication interface 135 is implemented via an antenna, circuits, chips, or other electronic components that facilitate wireless communication between the host vehicle 100 and the remote server 110. The communication interface 135 may be programmed to facilitate communication via any number of wired or wireless communication protocols. For instance, the communication interface 135 may transmit the alert message via a cellular communication protocol (3G, LTE, etc.), a satellite communication protocol, Bluetooth®, the Dedicated Short Range Communication (DSRC) protocol, WiFi, or the like. The communication interface 135 may be programmed to wirelessly transmit the alert message after the water sensors 115 detect water on the road. The communication interface 135 may be programmed to transmit the alert message in response to a command from the processor 155. That is, the command from the processor 155 causes the communication interface 135 to transmit the alert message to the remote server 110. The alert message may indicate that water has been detected on the road at the present location of the host vehicle 100, the present location of the host vehicle 100, the height H of the water sensor 115 relative to the ground, the incline of the host vehicle 100, and possibly other information.

The autonomous mode controller 140, implemented via circuits, chips, or other electronic components, is programmed to carry out various operations when the host vehicle 100 is operating in an autonomous or partially autonomous mode. The autonomous mode controller 140 receives data from various vehicle sensors, which may include a lidar sensor, a radar sensor, a vision sensor (i.e., an external camera 165), an ultrasonic sensor, etc. The autonomous mode controller 140 is programmed to output control signals in accordance with the signals received from the sensors. The control signals may be output to various actuators associated with steering, accelerating, and braking the host vehicle 100. Thus, the autonomous mode controller 140 may output the control signals to execute the autonomous mode for the host vehicle 100.

The user interface 145, which is implemented via circuits, chips, or other electronic components, presents information to and receives information from an occupant of the vehicle. The user interface 145 may be located, e.g., on an instrument panel in a passenger cabin of the vehicle, or wherever it may be readily seen by the occupant. The user interface 145 may include dials, digital readouts, screens such as a touch-sensitive display screen, speakers, and so on for providing information to the occupant, e.g., human-machine interface (HMI) elements. The user interface 145 may include buttons, knobs, keypads, microphone, and so on for receiving information from the occupant. For instance, as discussed in greater detail below, the user interface 145 may be used to present information, such as the water data received from the remote server 110 or a notification including an instruction to an operator of the host vehicle 100 that the host vehicle 100 can or cannot travel through the water on the road.

The memory 150 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory 150 may store data such as a virtual map used by the navigation system 130, the height H of the water sensors 115 located on the host vehicle 100, the present location of the host vehicle 100, previous locations of the host vehicle 100, instructions executable by various components of the road water detection system 105, the host vehicle 100, or both, such as the processor 155, the navigation system 130, the autonomous mode controller 140, the communication interface 135, the user interface 145, etc. The data stored in the memory 150 may be accessible to the processor 155, the navigation system 130, and possibly other components of the road water detection system 105, the host vehicle 100, or both.

The processor 155 is implemented via circuits, chips, or other electronic components that control certain operations of the road water detection system 105. For instance, the processor 155 is programmed to receive the alert signal generated by the water sensors 115. In response to receiving the alert signal, the processor 155 is programmed to generate an alert message. That is, the receipt of the alert signal may cause the processor 155 to generate the alert message. The processor 155 may generate the alert message to include various information. For instance, the alert message may indicate that water has been detected on a road, the present location of the host vehicle 100 when the water was detected, the water sensor 115 height relative to the road, and the incline of the host vehicle 100 at the time the road water was detected. The processor 155 is further programmed to command a communication interface 135 to transmit the alert message to the remote server 110.

In some instances, the processor 155 is programmed to detect the presence of road water, the depth of the road water, or both, based on signals received from the remote server 110. For instance, the processor 155 may be programmed to query the remote server 110 for road water data. Specifically, the query may request road water data according to the present location of the host vehicle 100. That could include water data for the present location of the host vehicle 100, a location in the path of the host vehicle 100, a location along a route developed by the navigation system 130 even if on a different road than the present location of the host vehicle 100, or the like. The processor 155 may query the remote server 110 may commanding the communication interface 135 to transmit the query to the remote server 110.

The response from the remote server 110 may include the requested water data, which could include the depth of the water on the road and the location of the water on the road as measured by other vehicles. The processor 155 may be programmed to compare the depth of the water on the road as indicated by the water data received from the remote server 110 and determine whether the host vehicle 100 can travel through the road water. For instance, the processor 155 may be programmed to access a threshold height from the memory 150 and compare that height to the depth of the road water. The threshold height may be a height associated with the water depth that the host vehicle 100 can travel through without the engine stalling. In an abundance of caution, the threshold height may be lower than the maximum water depth for the host vehicle 100. For instance, the threshold height may be the height H of the water sensors 115 relative to the ground.

From the comparison of the water data to the threshold height, the processor 155 may determine whether the host vehicle 100 should attempt to travel through the water on the road. The processor 155 may communicate such information to the driver of the host vehicle 100 or to the autonomous mode controller 140 if the host vehicle 100 is operating in an autonomous or partially autonomous mode. The processor 155 may communicate whether the host vehicle 100 should attempt to travel through the water on the road to the driver of the host vehicle 100 by generating a notification and commanding the user interface 145 to present the notification. The notification may indicate the depth of the water on the road. The notification may further include a warning to the driver that the host vehicle 100 should not be driven through the water or an instruction that the host vehicle 100 may be driven through the water on the road. If the processor 155 determines that the host vehicle 100 can be driven through the water on the road, the notification may indicate a maximum suggested speed (e.g., 5-10 mph) based on the depth of the water. In some instances, the processor 155 may output a control signal to, e.g., an engine controller that limits the vehicle speed until the host vehicle 100 is finished traveling through the water. In instances where the processor 155 determines that the host vehicle 100 should not be driven through the water on the road, the processor 155 may request that the navigation system 130 develop a new route around the water on the road, and the processor 155 may command the user interface 145 to present the new route to the driver.

When the host vehicle 100 is operating in an autonomous mode and the processor 155 determines that the host vehicle 100 should not travel through the water on the road, the processor 155 may output a control signal to the autonomous mode controller 140 preventing the autonomous mode controller 140 from driving the host vehicle 100, in an autonomous mode, through the water. The control signal may, e.g., set a flag in the autonomous mode controller 140 that requires the autonomous mode controller 140 to seek a different route. That is, the processor 155 setting the flag may cause the autonomous mode controller 140 to request a different route from the navigation system 130. Even when the flag is set, the autonomous mode controller 140 may be permitted to control the host vehicle 100 according to the different route. The processor 155 may remove the flag when the host vehicle 100 is no longer near the water on the road, when the navigation system 130 generates a new route that does not include the area with water on the road, or the like.

The processor 155 may not always be able to estimate the depth of the water on the road. For instance, the processor 155 may not be able to communicate with the remote server 110, or the host vehicle 100 may be the first vehicle to discover the water on the road. Some drivers may not be willing to test whether the water is deep enough to submerge the water sensors 115. Moreover, the autonomous mode controller 140 may be programmed to not drive through a road flood. In that case, the autonomous mode controller 140 may seek further instruction from a vehicle owner who may or may not be located inside the host vehicle 100. If road water is detected while an occupant is inside the host vehicle 100 but the depth of the water is unknown, the processor 155 may command the user interface 145 to prompt the occupant, via the user interface 145, to provider an instruction (e.g., a user input) that instructs the host vehicle 100 to attempt to travel through the road water or instructs the host vehicle 100 to find a different route that does not involve traveling through the water on the road. The processor 155 may provide a control signal to the autonomous mode controller 140 in accordance with the user input. That is, if the user input indicates an instruction to find a different route, the processor 155 may set a flag in the autonomous mode controller 140 that prevents the autonomous mode controller 140 from traveling through the road water. If the user input indicates an instruction to try to drive the host vehicle 100 through the road water, the processor 155 may output a control signal, to the autonomous mode controller 140, limiting the speed of the host vehicle 100 to, e.g., 5-10 mph. If the processor 155 receives the alert signal, which as discussed above would mean that one or more of the water sensors 115 are submerged, the processor 155 may generate the alert message, transmit the alert message to the remote server 110, and prompt the occupant for further instruction. For instance, the processor 155 may prompt the occupant, via the user interface 145, to indicate whether the host vehicle 100 should continue to travel through the road water or reverse and find a new route.

If the road water is detected without an occupant in the host vehicle 100 (i.e., the host vehicle 100 is operating in an autonomous mode) and the depth of the water is unknown, the processor 155 may command an external camera 165 (i.e., a camera located on the host vehicle 100 with a field of view ahead of the host vehicle 100) to capture an image of the flooded road. The processor 155 may be further programmed to command the communication interface 135 to transmit the image to the vehicle owner or another designated person. The contact information for the vehicle owner or other designated person may be stored in the memory 150. The processor 155 may include a message to the vehicle owner or other designated person requesting an instruction (i.e., a user input) for how to proceed. The user input may be provided to, e.g., a user's mobile device or a desktop or laptop computer and transmitted to the host vehicle 100. The communication interface 135 may receive the user input and transmit the user input to the processor 155. The processor 155 may determine the next course of action from the user input. For instance, if the user input indicates that the host vehicle 100 should travel through the water, the processor 155 may command the autonomous mode controller 140 to attempt to slowly travel through the water at a maximum speed of, e.g., 5-10 mph. If the user input indicates that the host vehicle 100 should not attempt to travel through the road water, the processor 155 may set the flag in the autonomous mode controller 140, which as discussed above may cause the autonomous mode controller 140 to find a different route.

FIG. 3 is an example circuit diagram of a water sensor 115 used in the road water detection system 105. The water sensor 115 includes a power source 170, resistors 175, a chip 180, a transistor 185, and leads 190 located in a housing 195. The power source 170 may be, e.g., a battery that electrically powers the resistors 175, the chip 180, and the transistor 185. The resistors 175, chip 180, and transistor 185 may be powered only when the leads 190 are electrically connected to one another, which may occur if the water sensor 115 is submerged. The housing 195 may be a water-tight enclosure for the power source 170, resistors 175, chip 180, and transistor 185. The leads 190 may extend out of the housing 195. That way, when submerged, the water may electrically connect the leads 190 without damaging other components of the water sensor 115. Connecting the leads 190 may cause electrical energy to flow from the power source 170 and ultimately to a node 200 at one terminal of the transistor 185. The chip 180 may be a timer chip, which may only permit electrical energy to flow to the node 200 if the leads 190 are connected for a minimum amount of time, such as 1-2 seconds. Thus, the chip 180 may prevent false positives due to rain, splashing by driving through a puddle, etc. The transistor 185 may act as a switch that allows current to flow to the node 200 when both leads 190 are submerged in water. The processor 155 may monitor the voltage at the node 200. The voltage at the node 200 may serve as the alert signal previously discussed. Thus, the processor 155 may detect a “high” voltage at the node 200 as the alert signal. Moreover, to further prevent false positives, the processor 155 may interpret a “high” voltage from the nodes 200 of multiple water sensors 115 as the alert signal. In other words, an alert signal output by one water sensor 115 may not be able to trigger the processor 155 to generate and transmit the alert message.

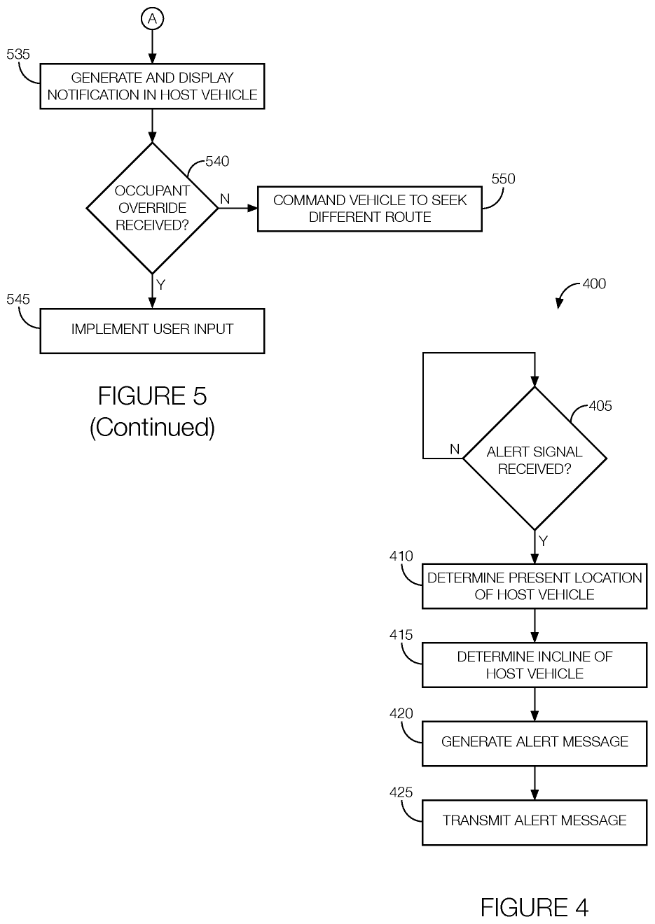

FIG. 4 is a flowchart of an example process 400 that may be executed by the road water detection system 105 to detect and report road water at the present location of the host vehicle 100. The process 400 may begin any time the host vehicle 100 is operating, whether in an autonomous or non-autonomous mode. The process 400 may continue to operate until the host vehicle 100 is turned off.

At decision block 405, the road water detection system 105 waits for the alert signal. The alert signal is generated when one or more water sensors 115 are submerged for a minimum amount of time (e.g., 1-2 seconds). The processor 155 may determine that the alert signal has been generated by monitoring the node 200, discussed above. When the processor 155 receives the alert signal, the process 400 may proceed to block 410. Otherwise, block 405 may be repeated until the alert signal is received or the host vehicle 100 is shut off.

At block 410, the road water detection system 105 determines the present location of the host vehicle 100. The processor 155 may determine the present location of the host vehicle 100 from signals output by the navigation system 130.

At block 415, the road water detection system 105 detects the incline of the host vehicle 100. That is, the processor 155 may receive and process the signal output by the inclinometer 125 to determine the incline of the host vehicle 100.

At block 420, the road water detection system 105 generates the alert message. The processor 155 may generate the alert message to indicate that water has been detected on the road, the present location of the host vehicle 100 when the water was detected, the incline of the host vehicle 100 at the time the water was detected, and the height H of the water sensor 115 on the host vehicle 100. The processor 155 may determine the height H of the water sensor 115, relative to the road, based on data stored in the memory 150. That is, the height H of the water sensor 115 may be the distance of the water sensor 115 from the surface of the road, measured perpendicularly. The height H of the water sensor 115 may not change so the height may be stored in the memory 150 during manufacture of the host vehicle 100.

At block 425, the road water detection system 105 transmits the alert message to the remote server 110. That is, the processor 155 may command the communication interface 135 to transmit the alert message to the remote server 110. In response to receiving such a command, the communication interface 135 may wirelessly transmit the alert message to the remote server 110 using a wireless communication protocol such as a cellular communication protocol or a satellite communication protocol.

The process 400 may end after block 425. In some instances, the process 400 may return to block 405 to await a subsequent alert signal.

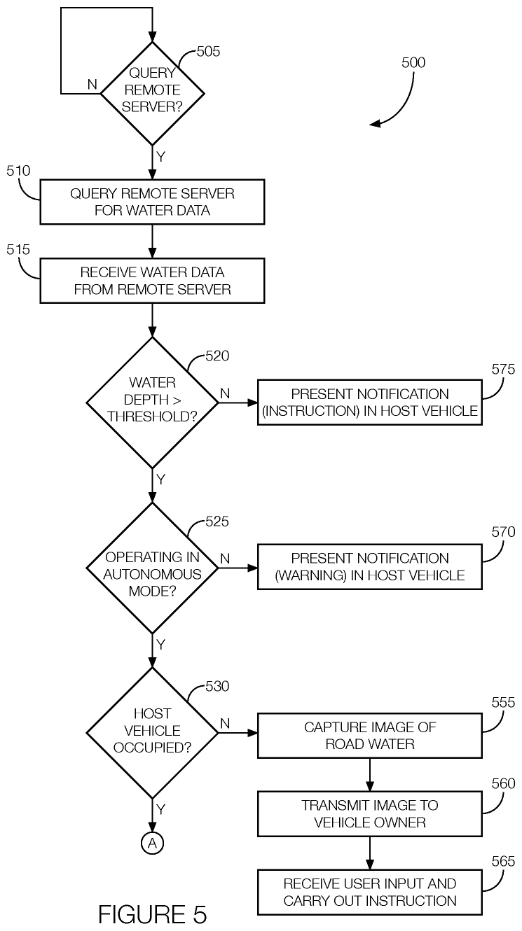

FIG. 5 is a flowchart of an example process 500 that may be executed by the road water detection system 105 to determine if the host vehicle 100 can travel through the water on the road. The process 500 may be initiated by various conditions, such as when the water sensor 115 detects water (i.e., outputs the alert signal) or when the host vehicle 100 is near road water. For instance, the process 500 may begin when the road water detection system 105 seeks information about water on the road. As discussed in greater detail below, this could include instances where the road water detection system 105 has not detected road water.

At decision block 505, the road water detection system 105 determines whether to query the remote server 110 for road water data. The processor 155 may select to query the remote server 110 for road water data under various circumstances. One example circumstance is if one or more water sensors 115 output the alert signal. Alternatively or in addition, the processor 155 may decide to query the remote server 110 for water data for some or all locations along the route of the host vehicle 100 developed by the navigation system 130. If the processor 155 determines that the remote server 110 should be queried for water data, the process 500 proceeds to block 510. Otherwise, block 505 may be repeated until the processor 155 decides to query the remote server 110 for water data or the process 500 is otherwise ended (e.g., the host vehicle 100 is turned off).

At block 510, the road water detection system 105 queries the remote server 110 for road water data. That is, the processor 155 may generate the query and command the communication interface 135 to transmit the query to the remote server 110. The query may include the present location of the host vehicle 100, locations along the route of the host vehicle 100, or both. Further, the query may request the depth of the water at the present location of the host vehicle 100, at the other locations indicated in the query, or both.

At block 515, the road water detection system 105 receives the water data from the remote server 110. The water data may be received via the communication interface 135 and transmitted to the processor 155 for processing. The water data may include the depth of the water at various locations, including the present location of the host vehicle 100 or a location along the route of the host vehicle 100.

At decision block 520, the road water detection system 105 compares the water depth represented by the water data to the threshold height, which as discussed above could be the height H of the water sensors 115. If the water depth exceeds the threshold height, the processor 155 may determine that the host vehicle 100 cannot travel through the water on the road. In this circumstance, the process 500 may proceed to block 525. If the water depth is below the threshold height, the processor 155 may determine that the host vehicle 100 can travel through the water on the road. In this circumstance, the process 500 may proceed to block 575.

At decision block 525, the road water detection system 105 determines the operating mode of the host vehicle 100. Examples of operating modes include an autonomous (e.g., driverless) mode or a non-autonomous mode of operation. The processor 155 may determine whether the host vehicle 100 is operating in an autonomous or non-autonomous mode of operation based on signals received from in-vehicle controllers, such as the autonomous mode controller 140. If the host vehicle 100 is operating in the autonomous mode, the process 500 may proceed to block 530. If the host vehicle 100 is not operating in an autonomous mode, the process 500 may proceed to block 570.

At decision block 530, the road water detection system 105 determines if the host vehicle 100 has any occupants. The processor 155 may detect occupants in accordance with an occupant detection system including, e.g., seat sensors, an interior camera, etc. If the processor 155 determines that the host vehicle 100 has at least one occupant, the process 500 may proceed to block 535. Otherwise, the process may proceed to block 555.

At block 535, the road water detection system 105 generates a notification that includes the water depth represented by the water data, a warning indicating that the host vehicle 100 cannot travel through the road water, and command the user interface 145 to display the notification in the host vehicle 100.

At decision block 540, the road water detection system 105 may determine whether an occupant override has been received. The occupant override may be received via a user input provided to the user interface 145. The occupant override may be a user input that instructs the host vehicle 100 to attempt to travel through the road water despite the warning of the notification. The process 500 may proceed to block 545 if the occupant override is received. The process 500 may proceed to block 550 if no occupant override is received.

At block 545, the road water detection system 105 implements the user input (i.e., the occupant override) received at block 535. The occupant override may cause the processor 155 to output a control signal to the autonomous mode controller 140 indicating that the occupant has instructed the host vehicle 100 to attempt to travel through the road water.

At block 550, the road water detection system 105 commands the host vehicle 100 to seek a different route. In this circumstances, the processor 155 may output a control signal preventing the autonomous mode controller 140 from controlling autonomous vehicle operations. That is, the control signal may set a flag in the autonomous mode controller 140 that prevents the autonomous mode controller 140 from driving the host vehicle 100 through the road water. Further, the processor 155 may command the navigation system 130 to generate a different route and command the autonomous mode controller 140 to follow the new route that excludes the road water. The process 500 may return to block 505 after block 550.

At block 555, the road water detection system 105 captures an image of the road water. That is, the processor 155 may command the external camera 165 to capture the image. The image may be temporarily stored in the memory 150.

At block 560, the road water detection system 105 transmits the image to the vehicle owner or another designated person. The processor 155 may access contact information for the vehicle owner or another designated person from the memory 150. The processor 155 may further transmit a prompt to the vehicle owner or other designated person to respond with instructions. That is, the vehicle owner or other designated person may look at the image and determine whether the host vehicle 100 can travel through the road water without stalling. The processor 155 may request that the vehicle owner or other designated person respond with instructions via a user input.

At block 565, the road water detection system 105 receives the user input with the instruction and carries out the instruction. For instance, if the user input indicates that the host vehicle 100 can travel through the road water without stalling, the processor 155 may instruct the autonomous mode controller 140 to operate the host vehicle 100 through the road water. If the user input indicates that the host vehicle 100 should not attempt to travel through the road water, the processor 155 may output a control signal preventing the autonomous mode controller 140 from driving the host vehicle 100 through the road water. As discussed above, this may include setting a flag in the autonomous mode controller 140. When the flag is set, the autonomous mode controller 140 is prevented from operating the host vehicle 100 through the water on the road. Moreover, the processor 155 may command the navigation system 130 to seek an alternate route that that autonomous mode controller 140 can use to avoid the road water.

At block 570, the road water detection system 105 presents a notification to the driver of the host vehicle 100. That is, the processor 155 may generate a notification and command the user interface 145 to present the notification to the driver. The notification may include a warning to the operator of the host vehicle 100 that the operator should not attempt to drive the host vehicle 100 through the road water.

At block 575, the road water detection system 105 presents a notification to the driver of the host vehicle 100. That is, the processor 155 may generate a notification and command the user interface 145 to present the notification to the driver. The notification may include an instruction to the operator of the host vehicle 100 that the host vehicle 100 should be able to travel through the road water without stalling.

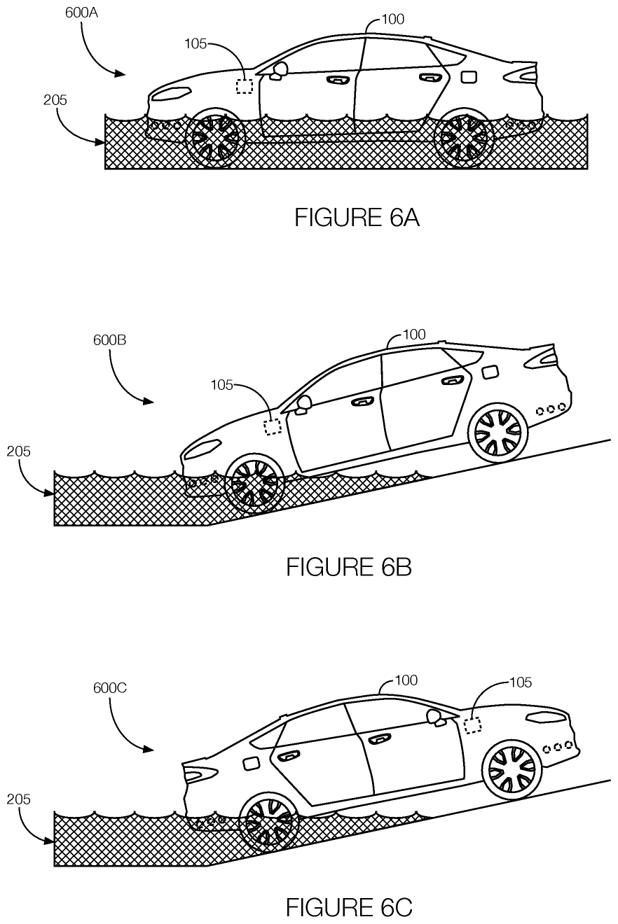

FIGS. 6A-6C illustrate example scenarios 600A-600C where the road water detection system 105 detects water on a road. FIG. 6A illustrates an example scenario 600A where the host vehicle 100 is traveling through road water 205. The road water 205 is high enough to trigger the water sensors 115. The road water detection system 105 reports the road water 205 to the remote server 110, as discussed above. FIGS. 6B and 6C illustrate example scenarios 600B and 600C, respectively, where the host vehicle 100 detects road water 205, but the host vehicle 100 is at an incline. In these instances, the road water detection system 105 reports the road water 205 to the remote server 110 along with the incline of the host vehicle 100 at the time the road water 205 was detected. The remote server 110 can determine that the depth of the water may be greater than the height H of the water sensor 115 since the host vehicle 100 was at an angle at the time the road water 205 was detected. Moreover, the remote server 110 may calculate the depth of the water if, e.g., the remote server 110 knows where the road levels off, the incline of the host vehicle 100 at the time the water was detected, and the location of the host vehicle 100 at the time the water was detected.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a water sensor that outputs an alert signal when submerged in water; and
a processor programmed to receive the alert signal, generate an alert message indicating that water has been detected on a road, a present location of a host vehicle, and a water sensor height relative to the road, and command a communication interface to transmit the alert message to a remote server.

2. The vehicle system of claim 1, further comprising an inclinometer programmed to detect a vehicle incline, wherein the processor is programmed to generate the alert message to indicate the vehicle incline detected by the inclinometer.

3. The vehicle system of claim 1, further comprising a navigation system programmed to determine the present location of the host vehicle and transmit the present location of the host vehicle to the processor.

4. The vehicle system of claim 1, wherein the processor is programmed to query the remote server for road water data.

5. The vehicle system of claim 4, wherein the processor is programmed to query the remote server for the road water data according to the present location of the host vehicle, the road water data including a water depth of a road associated with the present location of the host vehicle.

6. The vehicle system of claim 4, wherein the processor is programmed to query the remote server by commanding the communication interface to transmit the query to the remote server.

7. The vehicle system of claim 4, further comprising an autonomous mode controller programmed to control at least one autonomous vehicle operation, and wherein the processor is programmed to receive the road water data from the remote server and output a control signal preventing the autonomous mode controller from controlling the autonomous vehicle operation based at least in part on the water depth of the road received from the remote server.

8. The vehicle system of claim 5, further comprising a user interface, and wherein the processor is programmed to receive the road water data from the remote server, generate a notification, and output the notification to the user interface, the notification indicating the water depth of the road represented by the road water data received from the remote server.

9. The vehicle system of claim 8, wherein the processor is programmed to compare the water sensor height to the water depth, determine that the host vehicle cannot travel through the water on the road based on the water depth exceeding the water sensor height, generate the notification to include a warning to an operator of the host vehicle that the host vehicle cannot travel through the water on the road.

10. The vehicle system of claim 8, wherein the processor is programmed to compare the water sensor height to the water depth, determine that the host vehicle can travel through the water on the road based on the water depth being less than the water sensor height, and generate the notification to include an instruction to an operator of the host vehicle that the host vehicle can travel through the water on the road.

11. A method comprising:
receiving an alert signal generated by a water sensor;
generating an alert message indicating that water has been detected on a road, a present location of a host vehicle, and a water sensor height relative to the road; and
command a communication interface to transmit the alert message to a remote server.

12. The method of claim 11, further comprising detecting a vehicle incline, and wherein generating the alert message includes generating the alert message to indicate the vehicle incline.

13. The method of claim 11, further comprising determining the present location of the host vehicle.

14. The method of claim 11, further comprising querying the remote server for road water data.

15. The method of claim 14, wherein querying the remote server for road water data includes querying the remote server for a water depth of a road associated with the present location of the host vehicle.

16. The method of claim 15, further comprising outputting a control signal preventing an autonomous mode controller from controlling an autonomous vehicle operation based at least in part on the water depth of the road received from the remote server.

17. The method of claim 15, further comprising:
receiving the road water data from the remote server; and
generating a notification indicating the water depth of the road represented by the road water data received from the remote server.

18. The method of claim 17, further comprising:
comparing the water sensor height to the water depth; and
determining that the host vehicle cannot travel through the water on the road based on the water depth exceeding the water sensor height,
wherein generating the notification includes generating the notification to include a warning to an operator of the host vehicle that the host vehicle cannot travel through the water on the road.

19. The method of claim 17, further comprising:
comparing the water sensor height to the water depth; and
determining that the host vehicle can travel through the water on the road based on the water depth being less than the water sensor height,
wherein generating the notification includes generating the notification to include an instruction to an operator of the host vehicle that the host vehicle can travel through the water on the road.
